(19) United States
(12) Patent Application Publication
(10) Pub. No.: US 2021/0342806 A1
(43) Pub. Date: Nov. 4, 2021

(54) SYSTEM AND METHODS FOR AUTOMATIC DETECTION OF PRODUCT INSERTIONS AND PRODUCT EXTRACTION IN AN OPEN SHOPPING CART

(71) Applicant: Tracxone Ltd., Nesher (IL)

(72) Inventors: Moshe MEIDAR, Florida (US); Gidon MOSHKOVITZ, Haifa (IL); Edi BAHOUS, Haifa (IL); Itai WINKLER, Haifa (IL)

(21) Appl. No.: 17/267,843

(22) PCT Filed: Jan. 15, 2020
(86) PCT No.: PCT/IL2020/050064

§ 371 Date: Feb. 11, 2021

Related U.S. Application Data
(60) Provisional application No. 62/792,974, filed on Jan. 16, 2019.

(51) Int. Cl. G06Q 20/20; G06K 9/00

(52) U.S. Cl. CPC G06Q 20/203; G06K 9/0063; G06Q 20/208

(57) ABSTRACT

The disclosure relates to systems and methods for automatic detection of product insertion and product extraction in an Artificial Intelligent Cart (AIC). Specifically, the disclosure relates to systems and methods of ascertaining insertion and extraction of product into and from an open shopping cart, by continuously monitoring triggered content changes.

### COPYRIGHT NOTICE

A portion of the disclosure herein below contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND

The disclosure is directed to systems and methods for automatic detection of product insertion and product extraction in an Artificial Intelligent Cart (AIC). Specifically, the disclosure is directed to systems and methods of ascertaining insertion and extraction of product into and from an open shopping cart, by continuously monitoring triggered content changes.

With a dramatic increase in online shopping, consumers have gotten used to certain parameters that have become obvious. These include for example, the automatic identification of each purchased item without the need to re-identify the same item at check out, tallying of the amount purchased, and the option to remove and/or add items during the shopping experience.

Likewise, increase automation at points of sale (POS), and its integration with enterprise resource planning, have become an industry requirement on the retailers' side.

These factors have created a need to make the “brick and mortar” shopping experience, resemble more that of the online shopping experience, without necessarily compromising on stock management (ERP).

While attempts like Amazon Go, based on ceiling cameras and others, have tried to address some of the checkout issues, they do not address much else. For example, the Amazon go system is intended for use in relatively small footprint (the technology was implemented in a 1800 ft² store), which automatically means less product variety (hence smaller number of SKUs), the effectiveness and efficiency of the solution diminishes in sites such as big-box stores (e.g. Costco (US ˜143,000 ft²/4,000 SKUs), BJ's (US ˜72,000-113,000 ft²/7,200 SKUs), Sam's Club (US ˜134,000 ft²/6500 SKUs), etc.), large supermarkets (e.g., Kroger Co. (US >77,000 ft²), Tesco (UK, ˜50,000 ft²), etc.), or other large floor space retailers (e.g., Ikea (˜300,000 ft² in US), Home Depot (US ˜100,000 ft²), Walmart Supercenters (US ˜178,000)).

These and other shortcoming of the current state of affairs is addressed in the following description.

### SUMMARY

In an embodiment, provided herein are systems, methods and programs for ascertaining insertion and extraction of product into and from an open shopping cart.

In an embodiment, provided herein is an open shopping cart comprising: a cart body, the cart body having a floor, and walls rising from the floor, forming an apically open container; an inward-looking imaging module, adapted and configured to detect a first predetermined set of triggers associated with at least one of a product insertion or a product extraction; an outward-looking imaging module adapted and configured to detect a second predetermined set of triggers associated with at least one of a product insertion or a product extraction, wherein the second set of predetermined triggers is different than the first set of predetermined triggers; a load cell operably coupled to the floor of the cart body; and a central processing module (CPM), the CPM being in communication with the inward-looking imaging module, the outward-looking imaging module, and the load cell.

In another embodiment, provided herein is a computerized method of detecting insertion and/or extraction of a product from an open shopping cart implementable in a system comprising a cart body, the cart body having a floor, and walls rising from the floor, forming an apically open container; an inward-looking imaging module, adapted and configured to detect a first predetermined set of triggers associated with at least one of a product insertion or a product extraction; an outward-looking imaging module adapted and configured to detect a second predetermined set of triggers associated with at least one of a product insertion or a product extraction, wherein the second set of predetermined triggers is different than the first set of predetermined triggers; a load cell operably coupled to the floor of the cart body; and a central processing module (CPM), the CPM being in communication with the inward-looking imaging module, the outward-looking imaging module, and the load cell; the method comprising: capturing a first image of the open container using the inward looking imaging module; in response to a predetermined triggering event, capturing a second image of the open container using the inward looking imaging module; using the central processing module, comparing the first image to the second image, wherein if the second image is different than the second image, provide an indication of a product insertion or a product extraction.

In yet another embodiment, provided herein is a processor-readable media implementable in a computerized system comprising an open shopping cart comprising: a cart body, the cart body having a floor, and walls rising from the floor, forming an apically open container; an inward-looking imaging module, adapted and configured to detect a first predetermined set of triggers associated with at least one of a product insertion or a product extraction; an outward-looking imaging module adapted and configured to detect a second predetermined set of triggers associated with at least one of a product insertion or a product extraction, wherein the second set of predetermined triggers is different than the first set of predetermined triggers; a load cell operably coupled to the floor of the cart body; and a central processing module (CPM), the CPM being in communication with the inward-looking imaging module, the outward-looking imaging module, and the load cell, the CPM further comprising a non-volatile memory having thereon the processor readable media with a set of instructions configured, when executed to cause the central processing module to: capture a first image of the open container using the inward looking imaging module; in response to a predetermined triggering event, capture a second image of the open container using the inward looking imaging module; using the central processing module, compare the first image to the second image, wherein if the second image is different than the second image, provide an indication of a product insertion or a product extraction.

### BRIEF DESCRIPTION OF THE DRAWINGS

For a better understanding of the systems, methods and programs for ascertaining insertion and extraction of product into and from an open shopping cart, with regard to the embodiments thereof, reference is made to the accompanying examples and figures, in which:

FIG. 1—is a schematic illustration of an embodiment of the triggering system hardware components. The system utilizes multiple cameras and a weighing system located on the bottom. All cameras and weight system are connected to the processing unit. Each camera has its own field-of-view (FOV). All cameras are positioned to capture the entire cart's box potentially with an overlapping FOV's;

FIG. 2, Is a schematic illustration of the components' architecture and their interactions in a block format; and

FIG. 3, Is a process diagram. Current image frame and previous image frames (or a time-series thereof), are processed for object detection, optical flow, and change detection. The weight signal is processed to locate stable regions. Processed data is fused to a single decision for determination of product insertion/extraction or removal of false trigger(s).

### DETAILED DESCRIPTION

The disclosure provides embodiments of systems, methods and programs for ascertaining insertion and extraction of product into and from an open shopping cart.

The systems, methods and programs for ascertaining insertion and extraction of product into and from an open shopping cart, are configured to automatically identify inserted products out of a huge number of different available products, with imaging modules having multiple cameras and a weight system that are utilized for product recognition. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of the present disclosure.

Automatic detection of product insertion and product extraction (removal) events is an important preliminary step for the entire product recognition pipeline provided by the open shopping cart system. The Open shopping cart processor and decision making module, are typically in ‘standby mode’ until a triggering event associated with either product insertion or product extraction, has been detected. Upon occurrence of such an event, the system inference engine (in other words, a particular dedicated process or device that processes a given set of information to produce an inferred set of connections (topology) based on that information), is triggered to start product recognition.

In an embodiment, the system is configured to analyze and fuse data from different sensors' locations and sensor types, establishing whether an insertion or extraction event occurred. The different sensors used can be, for example, multiple optical cameras such as RBG cameras, Infrared cameras, depth cameras, and specialized weighing system (load cells) and algorithms intended to be robust to the open shopping cart's accelerations. Under typical conditions the open shopping cart is subjected to various movements, which can lead to false triggers caused, amongst others by; background changes, lighting variations, shadow variations (penumbras), cart acceleration and the like. Therefore, the system is designed to be able to distinguish real triggers (i.e. product insertions/extraction) from false ones, thus increasing both the specificity and selectivity of the system—hence its reliability.

Although in the open shopping cart the trigger system described herein can recognize events of product insertion and product extraction, and provide supplemental data for the events, it is not intended to provide product recognition ability.

The systems, methods and programs for ascertaining insertion and extraction of product into and from an open shopping cart is configured to provide several functionalities, for example, at least one of:
a) Identify events of product insertions into the open shopping cart;
b) Identify events of product extraction (removal) out from the open shopping cart;
c) Provide signals (triggers) for product insertion/extraction to the data acquisition module and the product recognition module;
d) Provide the system additional information on the insertion and or extraction of a product such as insertion location, weight and shape;
e) Filter false events of product insertions/extraction (false positives—specificity);
f) Detect missed events (deal with misdetections false negatives—selectivity); and
g) Fuse information from various sensor to a single decision

In order to accomplish these functionalities, the systems methods and programs provided herein, processes data from imaging modules comprising multiple cameras located in, on, and around the open shopping cart, and a specialized weighing system (load cell), located beneath the open shopping cart's floor or base. The imaging modules further comprise various digital cameras, with various optical capabilities, such as, for example, RGB cameras, Infrared (IR) cameras, and depth cameras. The load cell module (referring to any device that detects a physical force such as the weight of a load and generates a corresponding electrical signal) can be a specialized weighing module that is able to provide weight measurements under challenging cart motion dynamics that typically include various types of accelerations.

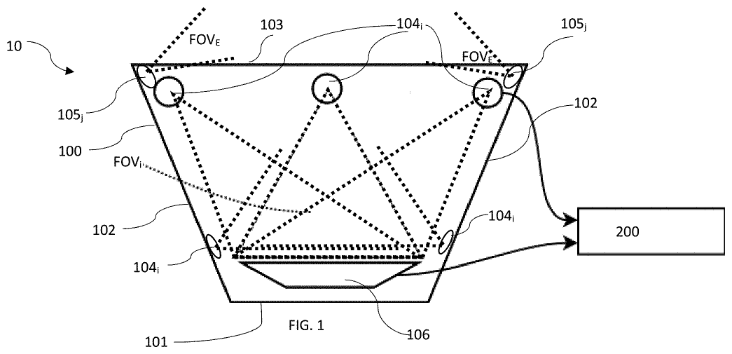

Accordingly and in an embodiment, illustrated in FIG. 1, provided herein is an open shopping cart 10 comprising: cart body 100, cart body 100 having floor 101, and walls 102 rising from floor 101, forming an apically open container defining rim 103, with inward-looking imaging module 104ᵢ, adapted and configured to detect a first predetermined set of triggers associated with at least one of a product insertion and a product extraction; an outward-looking imaging module 105ⱼ adapted and configured to detect a second predetermined set of triggers associated with at least one of a product insertion and a product extraction, wherein the second set of predetermined triggers is different than the first set of predetermined triggers; load cell 106, operably coupled to floor 101 of cart body 100; and central processing module (CPM) 200, CPM 200 being in communication with inward-looking imaging module 104ᵢ, outward-looking imaging module 105ⱼ, and load cell 106.

Although shown in an exemplary schematic illustration in FIG. 1, open cart 10, having body 100, is illustrated having a side view of generally quadrilateral cross section, other shapes are contemplated (e.g., round, polygonal and the like). Moreover, support elements, members, platforms, stages, shelves, tabs, ledges and the like used to support components of the inward-looking imaging module 104ᵢ, and outward-looking imaging module 105ⱼ, are also contemplated.

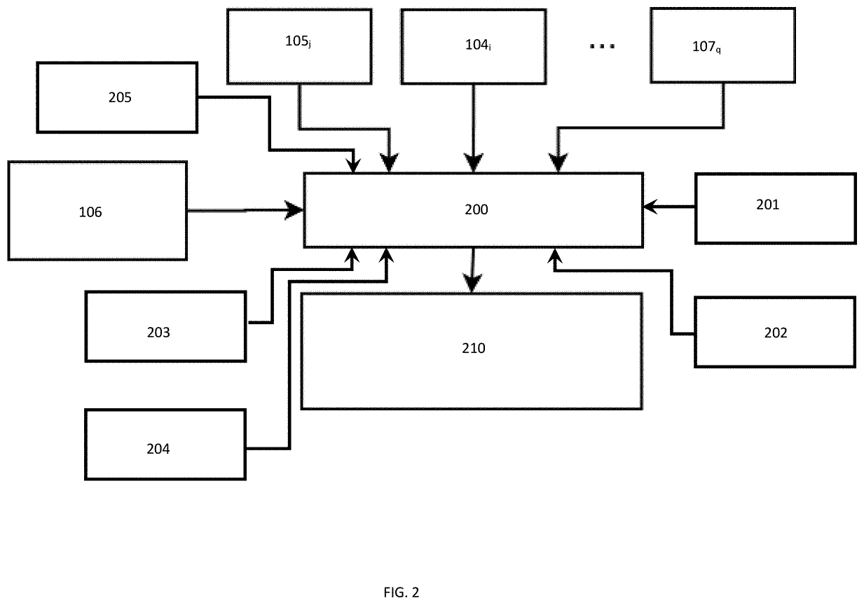

Turning now to FIG. 2, CPM 200 can be in further communication with at least one of: user interface module 201, graphics processing unit (GPU) 202, data acquisition module 203, product recognition module 204, a data fusion module 205, and a decision module 210. Also illustrated in FIG. 2, is sensor array 107_{q}, comprising a plurality of sensors such as, for example, a light meter, an accelerometer, an ultrasound detector, a RF transmitter/receiver, an infrared scanner, a barcode reader, a laser scanner, a camera based reader, a CCD reader, a LED scanner, a Bluetooth beacon, a near field communication module, a wireless transceiver, or a combination comprising one or more of the foregoing.

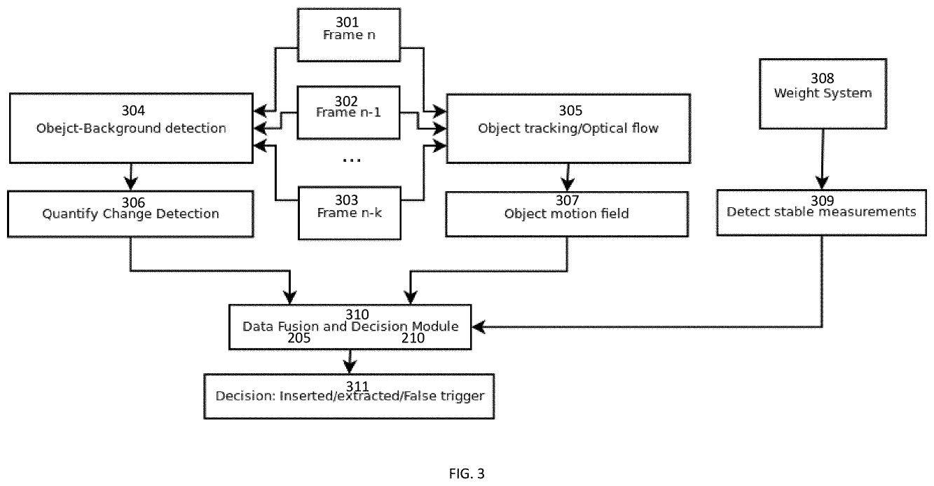

Processing module 200 is configured to collect, synchronize and pre-process the input data in order to prepare it for the ‘Data Fusion 205 and Decision’ 210 module. The processing system is in communication with a non-volatile memory, having thereon a processor-readable media with a set of executable instructions comprising various algorithms intended to process the obtained images and the weight signals. Further information on the processing algorithms are provided in FIG. 3.

The flowchart and block diagrams in FIGS. 2, and 3 illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Thus, ‘Data fusion 205 and Decision Module’ 210, which, in certain examples, can be joined to a single module, are configured to collects the processed data from ‘Processing Module’ 200, and fuses it to a single decision regarding product insertion or extraction (removal). Decision module 210 can therefore be able to distinguish false insertion/extraction events and thus avoid providing false triggers to the downstream modules. Furthermore, at least one of: user interface module 201, GPU 202, data fusion module 205, data acquisition module 203, product recognition module 204, and decision module 210, is co-located with CPM, or in another embodiment, are remotely coupled to CPM 200, for example by using wireless communication, wide area networks (internet), and the like.

In addition, the inward-looking imaging module 104ᵢ, and the outward-looking imaging module 105j, can each comprise one or more of RGB camera, Infrared (IR) camera (Thermographic camera), at least one RGBD camera, and at least one depth camera. For example, RGB-D cameras refer to sensing systems that capture RGB images along with per-pixel depth information. RGB-D cameras rely on either structured light patterns combined with stereo sensing, or time-of-flight laser sensing to generate depth estimates that can be associated with RGB pixels. Depth can also be estimated by various stereo-matching algorithms coupled with known camera position configuration. Also, the IR sensor, can comprise a non-contact device configured to detect infrared energy (heat) and convert it into an electronic signal, which is then processed to produce a thermal image on a display. Heat sensed by an infrared camera can be very precisely quantified, or measured, allowing to monitor thermal characteristics of products in the open shopping cart, and also identify insertion and removal of certain products.

It is noted that the term “imaging module” as used herein means a unit that includes a plurality of built-in image and/or optic sensors that can output electrical signals, which have been obtained through photoelectric conversion, as an image, while the term “module” refers to software, hardware, for example, a processor, or a combination thereof that is programmed with instructions for carrying an algorithm or method. The modules described herein may communicate through a wired connection, for example, a hard-wired connection, a local area network, or the modules may communicate wirelessly. The imaging module may comprise charge coupled devices (CCDs), a complimentary metal-oxide semiconductor (CMOS), an RGB-D camera, or a combination comprising one or more of the foregoing. If static images are required, the imaging module can comprise a digital frame camera, where the field of view (FOV) can be predetermined by, for example, the camera size and the distance from a point of interest in the cart. The cameras used in the imaging modules of the systems and methods disclosed, can be a digital camera, such as a digital still camera, or a digital video recorder that can capture a still image of an object and the like. The digital camera can comprise an image capturing unit or module, a capture controlling module, a graphic processing unit (which can be the same or separate from the central processing module).

The inward looking imaging module, used in the methods and programs implemented in the systems described, can comprise a plurality of cameras, positioned and configured to have an overlapping field of view (see e.g., FIG. 1), whereby an image captured by all the plurality of cameras, in combination with a signal provided by the load cell, or another sensor in sensor array 107q are together adapted to provide at least one of: the location of the inserted product within the shopping cart, the weight of the inserted product, and the shape of the product.

In other words, system 10 is configured to use multiple cameras including different camera types in order to improve the insertion/extraction event detection's accuracy and provide additional auxiliary information characterizing the items inserted/extracted. Example for such auxiliary information is the region in the cart where the event was detected, and/or the approximated size and weight of the inserted product (item). Other type of auxiliary information from cameras can originate from infrared cameras (i.e. Thermographic cameras). Infrared detection helps distinguish cold products such as frozen items from warmer ones and warmer products such as fresh baked goods. Another use for IR cameras is to separate customers' hands from products, increasing selectivity of the process. Other types of cameras used is RGBD (RGB+depth) where the depth information provides additional information about the change that occurred in the scene.

Accordingly, and in an embodiment, at least one of the insertion trigger or the extraction trigger is obtained by comparing a first image captured by the inward looking imaging module, to a second image captured by the inward looking imaging module, wherein the second image is captured following at least one of: a weight change indicated by the load cell and a triggering image captured by the outward-looking imaging module. Although, in certain embodiments, a single camera can cover the entire cart area or a fragment of it depending on its position and FOV orientation, with multiple cameras, an overlapping coverage of the product area defined by floor 101 and walls 102 can be achieved. This overlap in FOVs along with the weight data improves the accuracy of the system, as in some conditions, where the open shopping cart 10 may be occupied by products of varying package sizes and shapes, leading to partial or full occlusion of one or multiple cameras, reducing their ‘effective’ FOV. In such circumstances, the overlapping of cameras FOV's can compensate for such loss of visibility.

Moreover, the outward-looking imaging module can be positioned and configured (for example, using a digital RGB camera, and IR camera) to capture an image or plurality of images' sequence of at least one of: a hand gesture of a cart user (customer), an action of removing a product from a store shelf, an action of returning a product to a store shelf, an interaction of a customer with the store products, a motion of a product on a shelf, and a motion of a product across the open shopping cart 10 walls 102, or crossing rim 103, as well as additionally or alternatively, additional sensors part of sensor array 107q, which can be used to increase the specificity and selectivity of the product insertion/extraction detection by the system. For example, an indication from an accelerometer in sensor array 107_{q} of a stop in motion can trigger the inward-looking imaging module to capture an image of the open shopping cart 10 internal space, and automatically apply a Gaussian filter to the image. Following a change in weight detected by load cell 106, and/or an image or series of images captured by the outward-looking imaging module, a second image will be captured by the inward-looking imaging module, again apply the Gaussian filter and compare the two images, thus detecting the location, shape and weight of any inserted or extracted (removed) product.

Detecting customer's action and/or gesture using the outward-looking imaging module 105j, can be done as part of an integrated system with visual input interfaces. These can include various motion sensing technologies. Among the motion sensor technologies are vision systems that may include an action/gesture detection camera or multiple sensors such as an image sensor and a camera to detect user's actions/gestures as with the present disclosures. Utilization of this vision sensor technology can further comprise dedicated action/gesture detection camera (e.g., VisNir camera and image sensor with depth calibration (e.g., RGBD camera) as disclosed herein enable capture of hand gestures and customer's action. The image sensor with depth calibration may comprise a second camera for detecting a virtual detection plane in a comfortable spot selected by the user. Current state of the art algorithms for action/gesture recognition include a combination of convolutional-neural-networks (CNN) with recurrent-neural-networks (RNN) such as LSTM (Long-Short-Term-Memory) network.

In an embodiment, and as illustrated in FIG. 3, identifying product insertions/extractions within the open shopping cart is the first step in the product recognition pipeline provided. In order to obtain accurate detections of insertions/extractions various algorithms are applied by ‘Processing Module’ 200.

For example, camera images 301-303 and weight measurements 308 are first synchronized by their sampling time and images captured from each camera are processed to detect changes 304 in their field-of-view (FOV). In an embodiment the detection is based on comparing the most recent image 301 to the previous one 302 or to a predetermined number of previous images 303. For example, the amount of change that was detected in each camera image captured is quantified 306.

Quantifying the difference between two images can be done by, for example, performing background/foreground segmentation 304. One notable variant uses a Gaussian mixture to model the background and thus distinguish changes in the cameras FOV as captured by the image. Another background/foreground detection algorithm can be configured to utilize deep neural networks such as convolutional neural networks (CNN). These methods provide some robustness to lighting and shadow variations but the resulting accuracy is insufficient for product-grade trigger system. Thus other algorithms and fusion can be employed to achieve the proper detection robustness. Another type of image-based processing for detecting the change between two images or series of images can be by identifying the motion direction when there is a product passing through the camera's field of view. The direction of the motion is used as a factor to determine whether a product was inserted or taken out of the cart. Other techniques for obtaining motion filed between two images such as Optical flow and object tracking can also be used. The motion of products into- or out-of the open shopping cart, may be abrupt and fast, requiring higher motion resolution and higher frame rate (fps) capture. For example, a product that is thrown by a customer into the cart. In order to capture the product during such a fast motion, the trigger system utilizes cameras with high frame-rate capabilities. With such cameras it is possible to capture the product with minimal motion blur, and thus allowing optical flow and object tracking 305 to provide sufficiently accurate estimation of the products motion direction 307—ultimately determining whether a product insertion or product extraction took place.

Generally speaking, optical flow refers to the angular and/or translational rate of motion of texture in the visual field (FOV) resulting from relative motion between a vision sensor and other objects in the environment. In an embodiment, using optical flow provides information about the shape of objects in the scene (e.g., the store shelf, the internal space of the open shopping cart), which become determinate if the motion parameters are known, as well as recovery of target (e.g., customer's hand(s) motion parameters (e.g., towards, or away from open shopping cart 10). Calculating optical flow difference, can be done by extracting feature points, or in other words, a predetermined parameter in a sequence of moving images, using, for example, a gradient-based approach, a frequency-based approach, a correlation-based approach, or their combination. For example, in a gradient-based approach, a pixel point is found with a value that is minimized according to a variation of a peripheral pixel gray value and a variation of a gray value between image frames is then compared. In frequency-based approach, a differential value of all of pixel values in the image is utilized, by employing a band-pass filter for a velocity such as a Gabor filter. Conversely, correlation-based approach, is applied to a method of searching a moving object (e.g., the customer's hand) in a sequence of images.

Likewise, the IR cameras (a.k.a Thermographic cameras) process infrared data to extract information on temperature changes in their FOV. IR cameras may also contain RGB data. The infrared channel is used to differentiate human hands from products by capturing the different heat signatures. The use of infrared cameras can also be used to detect false triggers due to hands that move into the cart without products. For example, this can occur if a customer chooses to rearrange the products in the cart. In addition, the IR cameras can provide the ability to distinguish products by their temperature, such as distinguishing frozen products from room-temperature products. This is an auxiliary information that can later be used by the system's recognition module 204.

Also, the load cell module 106 provides weight measurements 308 in a pre-configured sampling rate (a.k.a. weight signal), or as a results of a trigger provided by another sensor. It is assumed that the cart will undergo significant acceleration during its travel within the store, producing noisy measurements that may falsely indicate a weight change. Therefore, the weight signal can be configured to be processed to obtain an accurate weight estimation and avoid false noisy measurements. Load cells 106 signal is processed by the ‘Processing Module’ 200 to filter the weight signal, establish the correct weight measurement and identify true weight changes that originate from product insertion/extraction. It is important to distinguish between events of product insertion/extraction into the cart from cart's accelerations producing false and intermittent weight changes. For example, one of the processing methods is used is to locate stable regions within the weight signals 309. These regions usually correspond to an immobile cart. An accurate and reliable weight estimation can be provided during such standstill phases. Statistic measures can also be used to identify an immobile or stationary cart from a moving one. Other data analysis methods can be used interchangeably to identify an immobile cart.

The process described is illustrated in FIG. 3, where current 301 and previous 302, 303 frames are processed for object-background detection 304 and change (gap, □) detection 306. The weight signal 308 is processed to locate stable regions 309 within the signal. Processed data is fused 310 to a single decision 311 for product insertion/extraction or false trigger.

In an embodiment, the methods described are implementable using the systems and programs provided. The computer program product of the present invention comprises one or more computer readable hardware storage devices having computer readable program code stored therein, said program code containing instructions executable by one or more processors of a computer system to implement the methods disclosed and claimed. Accordingly provided herein is a computerized method of detecting insertion and/or extraction of a product from an open shopping cart implementable in a system comprising a cart body, the cart body having a floor, and walls rising from the floor, forming an apically open container; an inward-looking imaging module, adapted and configured to detect a first predetermined set of triggers associated with at least one of a product insertion or a product extraction; an outward-looking imaging module adapted and configured to detect a second predetermined set of triggers associated with at least one of a product insertion or a product extraction, wherein the second set of predetermined triggers is different than the first set of predetermined triggers; a load cell operably coupled to the floor of the cart body; and a central processing module (CPM), the CPM being in communication with the inward-looking imaging module, the outward-looking imaging module, and the load cell; the method comprising: capturing a first image of the open container using the inward looking imaging module; in response to a predetermined triggering event, capturing a second image of the open container using the inward looking imaging module; using the central processing module, comparing the first image to the second image, wherein if the second image is different than the second image, provide an indication of a product insertion or a product extraction.

In another embodiment, data fusion 205 and decision module 210 makes decisions for events and send a signal/trigger to the software regarding the event time and type (i.e. insertion/extraction) along with auxiliary information on the event. The data fusion 205 and decision module 210 can be configured to distinguish false changes in the cameras and weight, due to the carts motion, from actual product insertions and extraction. To accomplish that the data fusion 205 and decision module 210 can, for example, identify the timing of insertions/extractions by fusing data from at least one of inward-looking imaging module 104ᵢ, outward-looking imaging module 150ⱼ, load cell module 106 and one or more sensors in sensor array 107_{q}. For example, if a camera detects change in its field-of-view, and a short duration after the load cell 106 detects a weight increase, the decision module may decide that an insertion event occurred and send a signal to CPM 200 to attempt to process the data for product recognition using product recognition module 204, that may be co-located in open shopping cart 10, or remotely communicating with CPM 200. If the weight has changed but the camera's FOV was unchanged when compared with most recent image (302), the module can decide that the weight change is due to cart accelerating and discard the information as a false measurement (trigger).

Moreover, data fusion 205 and decision module 210 can also be configured to track falsely-detected events and provide an appropriate signal at a later time. For example, falsely-detected insertion/extraction events can occur due to delayed weight stabilization that might occur during product insertion/extraction while open shopping cart 10 is still in motion. In such scenario, cart's 10 inward-looking imaging module 104ᵢ may capture sufficient change but the fusion module 205 may determine to wait until the signal received from load cell 106 can be accurately measured after open shopping cart 10 stopped.

Fusion module 205 searches in an embodiment, for corresponding changes from multiple sensors in sensor array 107_{q}, and/or outward-looking imaging module 105ⱼ that occur in a short and predetermined time interval. For example, two cameras can capture a significant change in their FOV, one of the high-speed cameras detects an object motion outside of the cart's box, and a short duration after the weight system is stabilized at a lower weight. In this scenario fusion 205 and decision module 210 may provide an extraction trigger. Suggesting that a product was removed from open shopping cart 10.

In one embodiment, the following equation can be used to produce insertion or extraction trigger signals. In a predefined time-window, a weighted sum of all changes in all cameras in all modules, along with the weight change signal provided by load cell 106 (Equ. 1):

Cₜₒₜ=c₁*Ch₁+c₂*Ch₂+c₃*Ch₃+c_{W}*|Δ_{W}|

Where:—Ch₁, Ch₂, Ch₃, are changes captured in cameras 1-3. |ΔW| is the change in weight;
c₁, c₂, c₃, c_{W} are empirical constants used to assign a weight to each element in the equation.
   Other formulas may also take into consideration other factors such as product motion filed, detection of customer hands and other factors.

In this embodiment, a trigger signal for insertion is provided if Cₜₒₜ>Threshold and Δ_{W}>0 (i.e. weight was added in the cart). Similarly, an extraction signal will be issued if Cₜₒₜ>Threshold and Δ_{W}<0.

Accordingly and in an embodiment, provided herein is a processor-readable media implementable in a computerized system comprising an open shopping cart comprising: a cart body, the cart body having a floor, and walls rising from the floor, forming an apically open container; an inward-looking imaging module, adapted and configured to detect a first predetermined set of triggers associated with at least one of a product insertion or a product extraction; an outward-looking imaging module adapted and configured to detect a second predetermined set of triggers associated with at least one of a product insertion or a product extraction, wherein the second set of predetermined triggers is different than the first set of predetermined triggers; a load cell operably coupled to the floor of the cart body; and a central processing module (CPM), the CPM being in communication with the inward-looking imaging module, the outward-looking imaging module, and the load cell, the CPM further comprising a non-volatile memory having thereon the processor readable media with a set of instructions configured, when executed to cause the central processing module to: capture a first image of the open container using the inward looking imaging module; in response to a predetermined triggering event, capture a second image of the open container using the inward looking imaging module; using the central processing module, compare the first image to the second image, wherein if the second image is different than the second image, provide an indication of a product insertion or a product extraction.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

The systems used herein can be computerized systems further comprising a central processing module; a display module; and a user interface module. The Display modules, which can include display elements, which may include any type of element which acts as a display. A typical example is a Liquid Crystal Display (LCD). LCD for example, includes a transparent electrode plate arranged on each side of a liquid crystal. There are however, many other forms of displays, for example OLED displays and Bi-stable displays. New display technologies are also being developed constantly. Therefore, the term display should be interpreted widely and should not be associated with a single display technology. Also, the display module may be mounted on a printed circuit board (PCB) of an electronic device, arranged within a protective housing and the display module is protected from damage by a glass or plastic plate arranged over the display element and attached to the housing.

Additionally, “user interface module” broadly refers to any visual, graphical, tactile, audible, sensory, or other means of providing information to and/or receiving information from a user or other entity. For example, a set of instructions which enable presenting a graphical user interface (GUI) on a display module to a user for displaying and changing and or inputting data associated with a data object in data fields. In an embodiment, the user interface module is capable of displaying any data that it reads from the imaging module. In addition, the term ‘module’, as used herein, means, but is not limited to, a software or hardware component, such as a Field Programmable Gate-Array (FPGA) or Application-Specific Integrated Circuit (ASIC), which performs certain tasks. A module may advantageously be configured to reside on an addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

As indicated, provided herein is a computer program, comprising program code means for carrying out the steps of the methods described herein, implementable in the systems provided, as well as a computer program product (e.g., a micro-controller) comprising program code means stored on a medium that can be read by a computer, such as a hard disk, CD-ROM, DVD, USB, SSD, memory stick, or a storage medium that can be accessed via a data network, such as the Internet or Intranet, when the computer program product is loaded in the main memory of a computer [or micro-controller] and is carried out by the computer [or micro controller].

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

In addition, the memory medium may be located in a first computer in which the programs are executed, and/or may be located in a second different computer [or micro controller] which connects to the first computer over a network, such as the Internet [or, they might be even not connected and information will be transferred using USB]. In the latter instance, the second computer may further provide program instructions to the first computer for execution.

Unless specifically stated otherwise, as apparent from the description, it is appreciated that throughout the specification discussions utilizing terms such as “processing,” “loading,” “in communication,” “detecting,” “calculating,” “determining”, “analyzing,” “presenting”, “retrieving” or the like, refer to the action and/or processes of a computer or computing system, or similar electronic computing device, that manipulate and/or transform data represented as physical, such as the captured and acquired image of the product inserted into the cart (or removed) into other data similarly represented as series of numerical values, such as the transformed data.

While the invention has been described in detail and with reference to specific embodiments thereof, it will be apparent to one of ordinary skill in the art that various changes and modifications can be made therein without departing from the spirit and scope thereof. Accordingly, it is intended that the present disclosure covers the modifications and variations of this invention provided they come within the scope of the appended claims and their equivalents.

1. An open shopping cart comprising:
a. a cart body, the cart body having a floor, and walls rising from the floor, forming an apically open container;
b. an inward-looking imaging module, adapted and configured to detect a first predetermined set of triggers associated with at least one of a product insertion and a product extraction;
c. an outward-looking imaging module adapted and configured to detect a second predetermined set of triggers associated with at least one of a product insertion and a product extraction, wherein the second set of predetermined triggers is different than the first set of predetermined triggers;
d. a load cell operably coupled to the floor of the cart body; and
e. a central processing module (CPM), the CPM being in communication with the inward looking imaging module, the outward-looking imaging module, and the load cell.

2. The open shopping cart of claim 1, wherein the CPM is further in communication with at least one of: a user interface module, a graphics processing unit (GPU), a data acquisition module, a product recognition module, a data fusion module, and a decision module.

3. The open shopping cart of claim 2, wherein at least one of the user interface module, the GPU, the data fusion module, the data acquisition module, the product recognition module, and the decision module, is co-located with the CPM.

4. The open shopping cart of claim 2, wherein at least one of the user interface module, the GPU, the data fusion module, the data acquisition module, the product recognition module, and the decision module, is located remotely to the CPM.

5. The open shopping cart of claim 3 or 4, wherein at least one of: the inward-looking imaging module, and the outward-looking imaging module comprise at least one of at least one RGB camera, at least one Infrared (IR) camera, at least one RGBD camera, and at least one depth camera.

6. The open shopping cart of claim 5, wherein the CPM is configured to at least perform one of:
a. identify events of product insertions into the open shopping cart;
b. identify events of product extraction out from the open shopping cart;
c. provide at least one trigger associated with at least one of product insertion and product extraction to the data acquisition module and the product recognition module;
d. recognize at least one of an insertion location of the inserted product, its weight, its shape, and a heat signature parameter;
e. filter false events of product insertions and/or product extraction: and
f. detect missed events.

7. The open shopping cart of claim 6, wherein the inward-looking imaging module comprises a plurality of cameras, positioned and configured to have an overlapping field of view, whereby an image captured by all the plurality of cameras, in combination with a signal provided by the load cell provides at least one of: the location of the inserted product within the shopping cart, the weight of the inserted product, the heat signature characteristic of the product, and the shape of the product.

8. The open shopping cart of claim 7, wherein the shopping cart further comprises at least one of a light meter, an accelerometer, an ultrasound detector, a RF transmitter/receiver, an infrared scanner, a barcode reader, a laser scanner, a camera based reader, a CCD reader, a LED scanner, a Bluetooth beacon, a near field communication module, and a wireless transceiver.

9. The open shopping cart of claim 8, wherein at least one of the insertion trigger or the extraction trigger is obtained by comparing a first image captured by the inward looking imaging module, to a second image captured by the inward looking imaging module.

10. The open shopping cart of claim 9, wherein the second image is captured following at least one of: a weight change indicated by the load cell and an image captured by the outward looking imaging module.

11. The open shopping cart of claim 10, wherein the outward-looking imaging module is positioned and configured to capture an image, or an image sequence, of at least one of: a hand gesture of a cart user, a cart user removing the product from a store shelf, a user holding a product, a motion of a product on a shelf, and a motion of a product across the open shopping cart walls.

12. A computerized method of detecting insertion and/or extraction of a product from an open shopping cart implementable in a system comprising a cart body, the cart body having a floor, and walls rising from the floor, forming an apically open container; an inward-looking imaging module, adapted and configured to detect a first predetermined set of triggers associated with at least one of a product insertion or a product extraction; an outward-looking imaging module adapted and configured to detect a second predetermined set of triggers associated with at least one of a product insertion or a product extraction, wherein the second set of predetermined triggers is different than the first set of predetermined triggers; a load cell operably coupled to the floor of the cart body; and a central processing module (CPM), the CPM being in communication with the inward-looking imaging module, the outward-looking imaging module, and the load cell; the method comprising:
a. capturing a first image of the open container using the inward looking imaging module;
b. in response to a predetermined triggering event, capturing:
i. a second image of the open container using the inward looking imaging module; and
ii. a plurality of images over a predetermined time using the outward looking imaging module, wherein the image captured by the outward looking imaging module is of at least one of: a hand gesture of a cart user, a cart user removing the product from a store shelf, a cart user holding a product, a motion of a product on a shelf, and a motion of a product across the open shopping cart wall; and
c. using the central processing module, comparing the first image to the second image of the inward looking imaging module and plurality of images captured by the outward looking imaging module, wherein if the second image is different than the first image, provide an indication of a product insertion or a product extraction.

13. The method of claim 12, wherein the predetermined trigger is an increase in weight provided by the load cell and the indication is of product insertion.

14. The method of claim 12, wherein the predetermined trigger is a decrease in weight provided by the load cell and the indication is of product extraction.

15. (canceled)

16. (canceled)

17. The method of claim 12, wherein at least one of: the inward-looking imaging module, and the outward-looking imaging module comprise at least one of at least one RGB camera, at least one Infrared (IR) camera, at least one RGBD camera, and at least one depth camera.

18. The method of claim 17, wherein the CPM is further in communication with at least one of: a user interface module, a graphics processing unit (GPU), a data acquisition module, a product recognition module, a data fusion module, and a decision module.

19. The method of claim 18, further comprising at least one of: a. providing at least one trigger associated with at least one of product insertion and product extraction to the data acquisition module and the product recognition module; b. recognizing at least one of an insertion location of the inserted product, its weight and its shape; c. filtering false events of product insertions and/or product extraction: and d. detecting missed events:

20. The method of claim 19, wherein the inward-looking imaging module comprises a plurality of cameras, positioned and configured to have an overlapping field of view, whereby the image captured by all of the plurality of cameras, in combination with a signal provided by the load cell provides at least one of: the location of the inserted product within the shopping cart, the weight of the inserted product, the shape of the product, and the heat signature characteristic of the product.

21. (canceled)

22. The method of claim 12, further comprising the step of: using the CPM, calculating an optical flow of a parameter and determining the flow direction of the parameter.

23. The method of claim 22, wherein the parameter is at least one of: the hand gesture of the cart user, and the product.

24. The method of claim 22, wherein the step of calculating the optical flow of the parameter, comprises at least one of: a gradient-based approach, a frequency-based approach, and a correlation-based approach.
